(19) United States
(12) Patent Application Publication
(10) Pub. No.: US 2010/0159319 A1
(43) Pub. Date: Jun. 24, 2010

(54) Battery Terminal Contact

(76) Inventor: Luther Gilford, Oak Park, MI (US)

Correspondence Address: JOHN R. BENEFIEL, 525 Lewis Street, BIRMINGHAM, MI, 48009, US

(21) Appl. No.: 12/641,349

(22) Filed: Jan. 19, 2010

Related U.S. Application Data
(60) Provisional application No. 61/268,386, filed on Jun. 11, 2009.
(60) Provisional application No. 61/203,469, filed on Dec. 23, 2008.

(51) Int. Cl. H01M 2/00

(52) U.S. Cl. 429/178

(57) ABSTRACT

A battery terminal positive contact formed as an annular rim which may be rounded or sharper or toothed to insure good electrical contact with a negative terminal contact or an external contact. An interengagement with another contact may be provided received within the rim to be located and retained thereby.

### CROSS REFERENCE TO RELATED APPLICATIONS

This application claims the benefit of U.S. provisional application No. 61/268,386 filed on Jun. 11, 2009, and No. 61/203,469 filed on Dec. 23, 2008.

### BACKGROUND OF THE INVENTION

This invention concerns battery terminals of a type having a short projecting flat topped post at the positive terminal end of the battery and a substantially flat area at the negative terminal end of the battery. The positive terminal contacts engage either an external contact of a using device or engages the negative terminal contact of a next adjacent battery placed in series.

For such common applications as TV remote controllers, etc. a common problem is maintaining a good quality contact engagement of the battery terminal contacts with each other and with the external contacts. The electrical resistance of the contacts may be significantly increased by a reduction in contact area due to local misalignments and/or by corrosion of the surfaces in engagement small particulars of foreign matter may also interrupt the contact.

A well-documented problem with standard dry-cell, miniature, and other types of batteries is the oxidation and sulfidation of the battery's positive terminals. Oxide and sulfide layers often develop over time usually on the flat portion of the positive terminal. Many battery manufacturers use a nickel-based coating to reduce the oxidation. These corrosive films are surface contaminants that create increased electrical resistance to direct current flow from the battery terminal. Contact resistance is the electrical resistance in the battery circuit attributable to the physical contact between terminal surfaces of adjacent batteries and between the batteries and the device contacts. In circumstances in which the terminals have built up an insulating contaminant layer, the contact resistance can be significant, consuming valuable battery power, particularly in high current applications. This can result in intermittent power failures, decreased power availability and increasing the rate at which the batteries need to be replaced or recharged.

Attempts have been made to improve the reliability of achieving a good engagement of the contacts, including forming a sharp protrusion on the projecting post positive terminal or on the flat negative terminal which tends to penetrate any slight film of corrosion on the terminal or external contacts which may otherwise create an increased electrical resistance at the point of contact. However, this establishes a point contact of a very reduced area, which itself increases the electrical resistance.

The normally flat negative terminals have in the past been formed with a recessed annular groove which tends to increase slightly the contact area extending about the perimeter of the post contact of the positive terminal.

This design is an improvement if good alignment exists but a reduced contact area will result if misalignment occurs.

Another problem is created by the presence of tiny particles of foreign material getting between the terminal or external mating contacts which may interrupt the electrical contact.

Also when a device is dropped, jarred or undergoes rough handling, the batteries tend to shift if the battery compartment allows any movement of the battery.

It is an object of the present invention to provide a battery terminal of the type described in which better electrical contact is able to be more reliably achieved even in the presence of contaminants and even if the device is dropped or otherwise jarred.

### SUMMARY OF THE INVENTION

The above object and other objects which will be understood by those skilled in the art upon a reading of the following specification and claims are achieved by forming the positive terminal contact in an annular shape defined by a rim having an end surface which engages the mating contact of the next battery or an external contact of a device in which the battery is used.

The rim of the battery terminal contact may create an approximate line contact with a mating flat contact. The end surface of the rim being narrow will tend to penetrate any corrosion film and the central depressed area can receive any tiny particles which can be displaced from the end surface so that the incidence of loss of contact area will be reduced.

In addition, the ring or rim shape interengages the annular groove shape used on some battery negative terminal contacts to maintain good alignment between two batteries placed in series to better insure maintenance of line contact between the rim and annular groove contacts resistant to being displaced by shocks as well as to increase the contact area between the rim and sides of the groove. The cavity within the rim is able to receive any displaced foreign particles to avoid any separation of the mating surfaces which would otherwise be created between the contacts.

In another embodiment, the ring contact can have a series of pointed features around the rim end surface of the contact which will effectively penetrate any film while still having a relatively large contact area comprised of the sum of the contacting areas of each point which providing the other advantages of the annular configuration.

In yet another embodiment a separate ring auxiliary is installed on a conventional positive terminal post with an engagement of a circular array of radially inward facing teeth with the perimeter of the post and also and axially projecting series of teeth defining pointed contacts to engage an external contact or negative terminal of another battery.

### DESCRIPTION OF THE DRAWING FIGURES

FIG. 1 is an enlarged pictorial view of a battery having formed thereon a positive terminal contact according to the present invention.

FIG. 2 is a further enlarged fragmentary side view of a battery having a positive terminal contact as shown in FIG. 1 and a juxtaposed external contact having a bead shape adapted to be mated therewith.

FIG. 2A is a greatly enlarged fragmentary diagrammatic view of the terminal contact and external contact of FIG. 2 shown mated together.

FIG. 3 is a fragmentary pictorial view of a battery having a positive terminal contact as shown in FIG. 1 juxtaposed to a flat negative battery terminal contact adopted to be mated therewith.

FIG. 3A is an enlarged diagrammatic side view of the contacts shown in FIG. 3 in engagement.

FIG. 4 is a pictorial view of a battery having a positive terminal contact as shown in FIG. 1 with a juxtaposed negative terminal opposite end of another battery having a negative terminal contact of an annular groove shape.

FIG. 4A is an enlarged diagrammatic view of the battery terminal contact shown in FIG. 4 in a mating engagement.

FIG. 5 is a pictorial negative terminal end of a spiral design juxtaposed to a battery having a positive terminal contact according to the present invention.

FIG. 6 is a sectional view through an alternate positive terminal contact according to the present invention wherein a series of teeth are formed about the rim of a ring shaped contact.

FIG. 7 is an enlarged pictorial view of the positive terminal end of a conventional battery having an auxiliary ring contact according to another embodiment of the invention secured to the battery terminal.

FIG. 8 is a pictorial view of the auxiliary ring contact shown installed in FIG. 7.

FIG. 9 is a pictorial reverse view of the auxiliary ring contact shown in FIG. 8.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to FIG. 1, a battery 10 has a positive terminal contact 12 according to the present invention. The contact 12 has a ring shape defined by a projecting rim 14 with a central defined space 16.

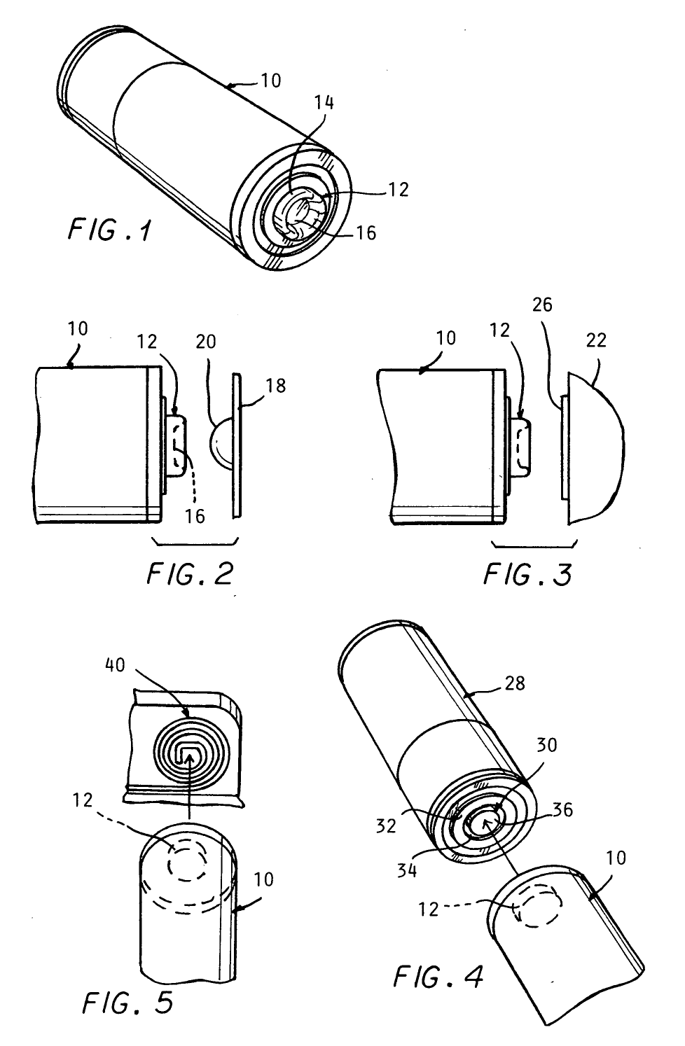

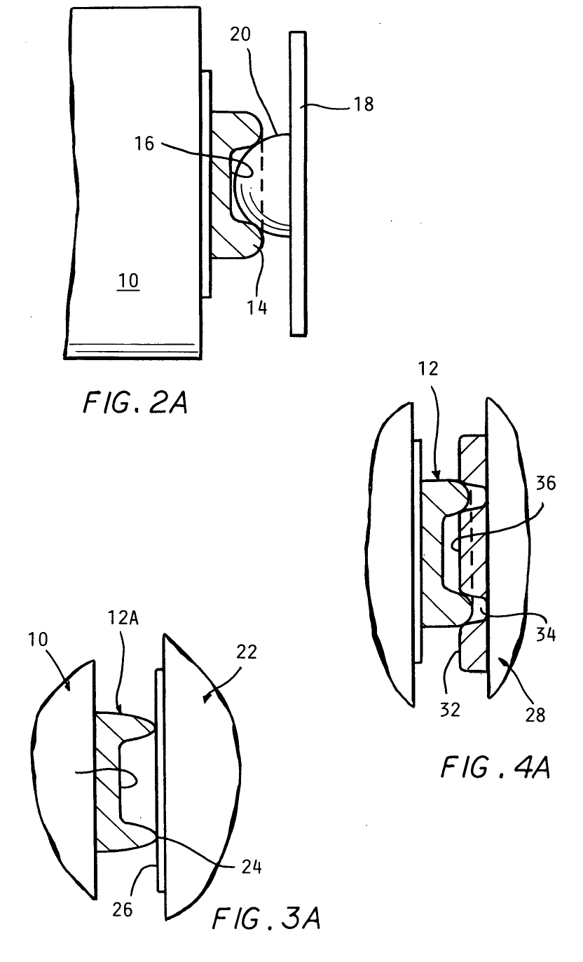

FIG. 2 depicts a juxtaposed external contact 18 defined by a generally hemispherical projection or bead 20 which is adapted to be mated therewith by being received in the central space 16 of contact 12. The will produce a hemispherical area of contact comprised of an annular strip contact area even with some misalignment therebetween. See FIG. 2A.

FIG. 3 depicts the negative terminal flat end of a battery 22 in juxtaposition to a battery having the positive terminal contact 12 according to the invention. The outer end surface 24 of the contact 12A provides a line narrow or area surface contact which will tend to penetrate any contaminant or corrosion present on the surface 24 or the flat surface 26 defining the negative terminal contact. The radius of the rim may be made narrower to present a sharper surface when engaging a flat contact. See FIG. 3A.

In addition, any tiny particles will tend to be displaced into the central space 16 and thus not interrupt the establishment of an electrical contact.

Any misalignments tend to result in a line contact rather than the substantially point contact resulting with a conventional post shape of the positive terminal contact described above.

Referring to FIGS. 4 and 4A, a battery 28 having a negative terminal contact 30 is comprised of a flat surface 32 having an annular groove 34 recessed therein creating a central flat area 36. When a battery 10 having a positive terminal contact 12 according to the invention is mated therewith an interlock tends to be created between the run 14 and annular groove 34 and rim 14 tending to maintain the mating ends of the two battery ends in alignment even when subjected to shocks.

In addition, a thin strip area contact tends to be maintained therebetween.

The spiral type external contact 40 is represented in FIG. 5 is engaged with the positive terminal contact shown in FIGS. 1 and 2. In this case, the rim 14 presses against the contact 40 and will partially align with spiral turns. The concentrated sharper area of the rim 14 tends to penetrate any contamination to insure a good quality contact.

Many other configurations of external contacts are known and the present invention improves the quality and reliability of the electrical contact therewith.

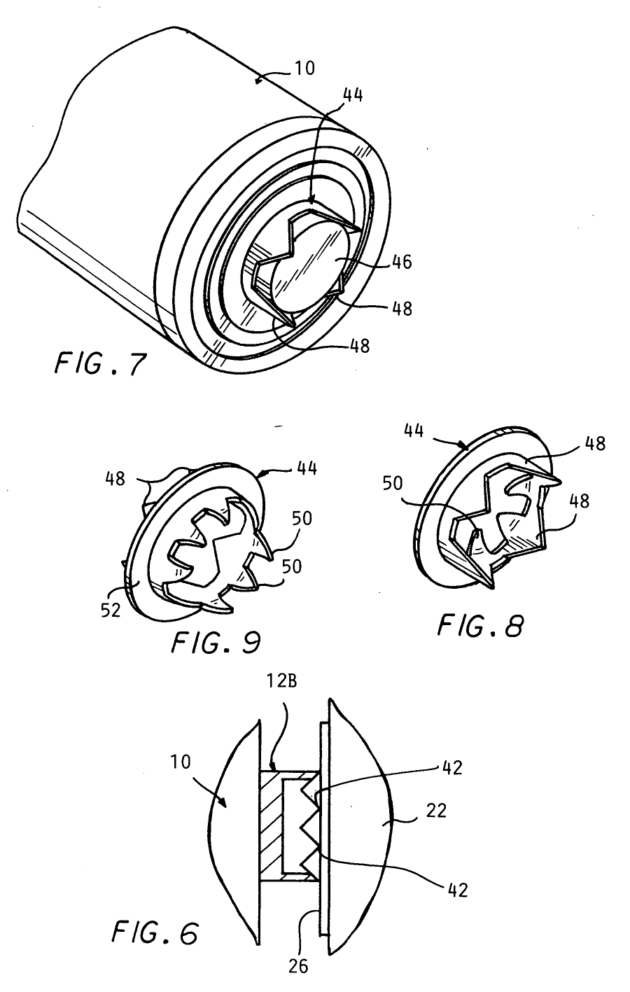

Referring to FIG. 6, a positive terminal contact 12B is configured with a series of axially facing teeth 42 arranged around the perimeter of the contact 12B. These engage with a flat negative terminal contact 26 so as to penetrate any contaminant film while still aggregating a substantial cross sectional contact area due to the presence of a number of teeth. A greater number of teeth can be provided to correspondingly increase the aggregate contact area.

FIGS. 7-9 show a separate auxiliary contact ring 44 installed on the post 46 of a conventional positive terminal of a battery 10.

The contact ring 44 has oppositely directed sets of teeth 48, 50 projecting from opposite sides of a flange 52.

Teeth 50 are angled radially inwardly to engage the perimeter of the post 46 while teeth 48 extend axially to engage an external contact or a contact of an adjacent battery (not shown).

This allows conversion of the positive post terminal of a conventional battery to a terminal contact according to the invention.

1. A battery having positive and negative terminals at opposite ends adapted to be pressed against an opposite polarity terminal contact in a series of batteries or a contact of an external device, said battery positive terminal having a contact comprising a short round post projecting from a main body of said battery and formed as a projecting rim defining a central space within said rim.

2. The battery according to claim 1 wherein said rim has an end surface which is rounded.

3. The battery according to claim 1 wherein said rim has a sharp end surface creating a line contact with a mating contact.

4. The battery according to claim .1 wherein a series of axially projecting teeth are formed about said rim.

5. The battery according to claim 4 wherein said contact comprised of a separate ring having a second series of teeth inclined radially inwardly and engaging a post positive terminal of a battery.

6. The battery of claim 1 further combined with another contact partially received within said central space and engaging an inside surface of said rim to tend to be maintained in contact thereby.
